(19) United States
(12) Patent Application Publication
(10) Pub. No.: US 2025/0269463 A1
(43) Pub. Date: Aug. 28, 2025

(54) SYSTEMS AND METHODS FOR LASER ABLATION

(71) Applicants: Nielson Scientific, LLC, Provo, UT (US); Brigham Young University, Provo, UT (US)

(72) Inventors: Gregory Nolan NIELSON, Lehi, UT (US); Stephen SCHULTZ, Provo, UT (US); Jared PAYNE, Pocatello, ID (US)

(21) Appl. No.: 18/858,573

(22) PCT Filed: Apr. 18, 2023
(86) PCT No.: PCT/US2023/018979

§ 371 Date: Oct. 21, 2024

Related U.S. Application Data
(60) Provisional application No. 63/332,309, filed on Apr. 19, 2022.

(51) Int. Cl. B23K 26/067; B23K 26/0622

(52) U.S. Cl. CPC B23K 26/067; B23K 26/0622

(57) ABSTRACT

Various technologies are described herein pertaining to laser ablation of material from a workpiece. An ablation system includes a laser, a focusing system, and a computing device configured to control operation of the laser and the focusing system. The laser emits light that is received by the focusing system. The computing device controls operation of the laser and/or the focusing system such that the focusing system focuses the light emitted by the laser to a focal spot on a surface of a workpiece. The focused light causes ablation of the workpiece at the focal spot.

### RELATED APPLICATION

This application is the U.S. National Stage Entry of PCT/US2023/018979, filed on Apr. 18, 2023, and entitled “SYSTEMS AND METHODS FOR LASER ABLATION”, which claims priority to and all benefit of U.S. Provisional Patent Application No. 63/332,309, filed on Apr. 19, 2022, and entitled “SYSTEMS AND METHODS FOR LASER ABLATION,” the contents of which are incorporated herein by reference in its entirety.

### STATEMENT OF GOVERNMENTAL INTEREST

This invention was made with Government support under Contract No. DE-SC0021786 awarded by the United States Department of Energy. The U.S. Government has certain rights in the invention.

### BACKGROUND

Microfabrication refers to a variety of techniques that are used to manufacture integrated circuits (ICs) and micro-electro-mechanical systems (MEMS). ICs and MEMS manufactured by way of conventional microfabrication techniques have feature sizes on the order of microns or nanometers. Conventionally, microfabrication of ICs and MEMS is a layer-by-layer process wherein layers of semiconductors (and various other materials) are deposited, patterned with lithographic tools, and then etched to define a portion of the final geometry. Generally, these conventional microfabrication techniques are limited to creating structures with shapes that are analogous to two-dimensional extruded geometries, sometimes referred to as 2.5D.

Furthermore, these conventional microfabrication techniques are complex, time-consuming, and costly. In an example, fabrication of a single layer of a device can include steps of 1) depositing a thin film on a substrate or wafer, 2) coating the thin film with a photoresist masking layer, 3) photolithographic patterning of the photoresist masking layer, 4) etching the thin film layer through the photoresist masking layer, 5) stripping the photoresist masking layer, and 6) thoroughly cleaning the substrate or wafer prior to a subsequent layer being deposited and patterned in similar fashion. Still further, these techniques cannot readily be employed with some materials, limiting their usage to certain classes of materials.

### SUMMARY

The following is a brief summary of subject matter that is described in greater detail herein. This summary is not intended to be limiting as to the scope of the claims.

Various technologies pertaining to laser ablation of micro-scale features on a workpiece are described herein. A laser ablation system includes a computing device, a laser, and a focusing system. The computing device is configured to control operation of the laser, the focusing system, and/or other components of the laser ablation system. The laser is configured to output a beam of light that is received and focused by the focusing system. The focusing system is configured to focus the beam to a small focal spot on or within a workpiece. In exemplary embodiments, the focal spot can have a spot width of less than 2 microns, less than or equal to one micron, or less than or equal to 500 nanometers. The laser ablation system can be configured such that the beam of light has sufficient power to cause ablation of material from the workpiece at the focal spot, but insufficient power to cause ablation of material at locations along the beam that are not proximal to the focal spot. Accordingly, the laser ablation system can be finely controlled to cause ablation at desired locations on or within a workpiece. Further, the laser ablation system can be employed to form features on the workpiece wherein such features can be less than one micron in size.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary laser ablation system.

FIG. 2 is a diagram illustrating positions of beams and their respective ablation regions relative to a surface of a workpiece.

FIG. 3 is a diagram of an exemplary confocal microscope system.

FIG. 4 is a functional block diagram of another exemplary laser ablation system.

FIG. 5 is a functional block diagram of still another exemplary laser ablation system.

FIG. 6 is a functional block diagram of yet another exemplary laser ablation system.

FIG. 7 is a conceptual diagram illustrating overlap of laser beams within the bulk of a workpiece.

FIG. 8 is a functional block diagram of still yet another exemplary laser ablation system.

FIG. 9 is a flow diagram illustrating a methodology for selective laser ablation.

FIG. 10 is an exemplary computing system.

### DETAILED DESCRIPTION

Various technologies pertaining to selective laser ablation are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

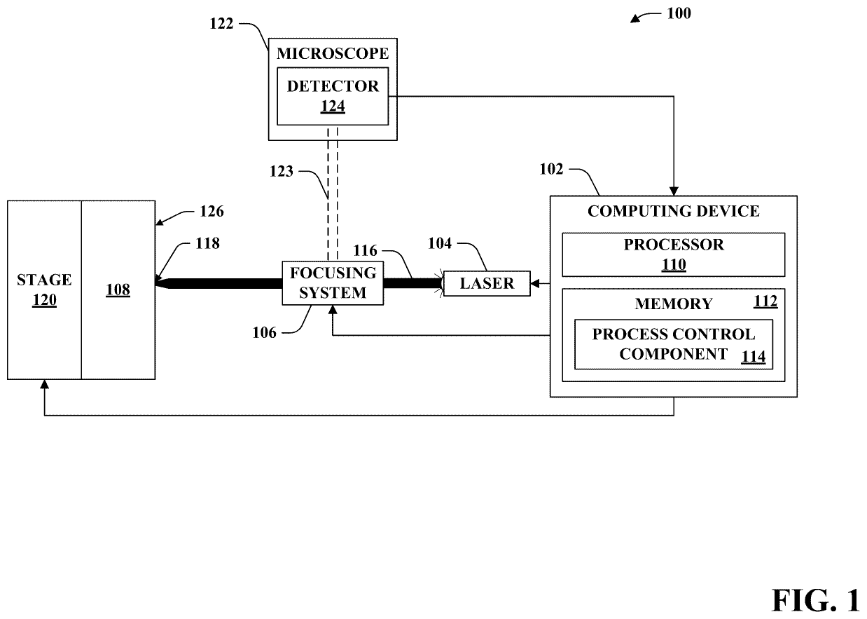

With reference to FIG. 1, an exemplary laser ablation system 100 is illustrated. The laser ablation system 100 includes a computing device 102, a laser 104, a focusing system 106, and a workpiece 108. The computing device 102 includes a processor 110 and memory 112. The memory 112 further comprises a process control component 114 that, when executed by the processor 110, is configured to control operation of the laser 104 and/or the focusing system 106.

The laser 104 outputs a beam of light 116. The laser 104 can be a pulsed laser such as a femtosecond laser that creates high-intensity, short-duration pulses of light. The beam 116 is received by the focusing system 106. The focusing system 106 comprises one or more optical elements that are collectively configured to focus the beam 116 to a focal spot 118 on a surface of the workpiece 108 or within the body of the workpiece 108. The focusing system 106 is configured to focus the beam 116 such that the focal spot 118 has a small diameter (e.g., less than 2 microns, less than or equal to one micron, or less than or equal to 500 nanometers). The focusing system 106 is further configured to focus the beam 116 such that the beam 116 has a shallow depth of focus (e.g., less than or equal to 10 microns, less than or equal to 5 microns, or less than or equal to 1 micron). The depth of focus, in an example, is the Rayleigh range. In another example, the depth of focus is the confocal parameter. In an exemplary embodiment, the focusing system 106 comprises one or more optical elements having a high numerical aperture that collectively have a high numerical aperture. In a non-limiting example, the focusing system 106 can have a numerical aperture of greater than or equal to 0.15, greater than or equal to 0.42, or greater than or equal to 0.55.

In various exemplary embodiments, the focal spot 118 of the beam 116 can be scanned laterally (e.g., along a flat surface of the workpiece 108) by the focusing system 106. For example, the focusing system 106 can include a galvanometer optical scanner, an acousto-optic deflector (AOD), or an electro-optic deflector (EOD) that can be controlled by the process control component 114 to deflect an angle of propagation of the laser beam 116. In further embodiments, the laser ablation system 100 can include a stage 120 that can translate in one or more directions. In exemplary embodiments, the stage 120 can be a three-axis stage capable of translation along three orthogonal axes. In some embodiments, the stage 120 can be a six-axis stage capable of translation along and rotation about three orthogonal axes. The workpiece 108 can be mounted on the stage 120, and process control component 114 can scan the focal spot 118 across a surface of the workpiece 108 by controlling the stage 120 to move the workpiece 108 relative to the beam 116.

The shallow depth of focus of the beam 116 imparted by the focusing system 106 allows the system 100 to ablate very fine features on a workpiece to precisely-controlled depths. In a non-limiting example, the system 100 can selectively ablate away a thin film of metal (e.g., less than 2 microns thick) deposited on a plastic substrate while leaving the plastic substrate intact, even though the power required to ablate the plastic substrate within a given area may be much lower than the power required to ablate the metal film. Fine features typically require an energy density per laser pulse of approximately 0.1 J/mm² to ablate, which can be higher or lower depending on the absorption of the material being ablated. The overall power imparted to the workpiece is dependent on the total energy per pulse as well as the frequency of pulses that create the laser beam.

As the beam 116 propagates away from the focal spot 118, the power imparted to the workpiece 108 by the beam 116 decreases. The shallow depth of focus imparted to the beam 116 by the focusing system 106 defines an ablation region within which the power imparted to the workpiece 108 by the beam 116 is sufficient to cause ablation of a material of the workpiece 108, and outside of which the power imparted by the beam 116 is insufficient to cause ablation of the material of the workpiece 108.

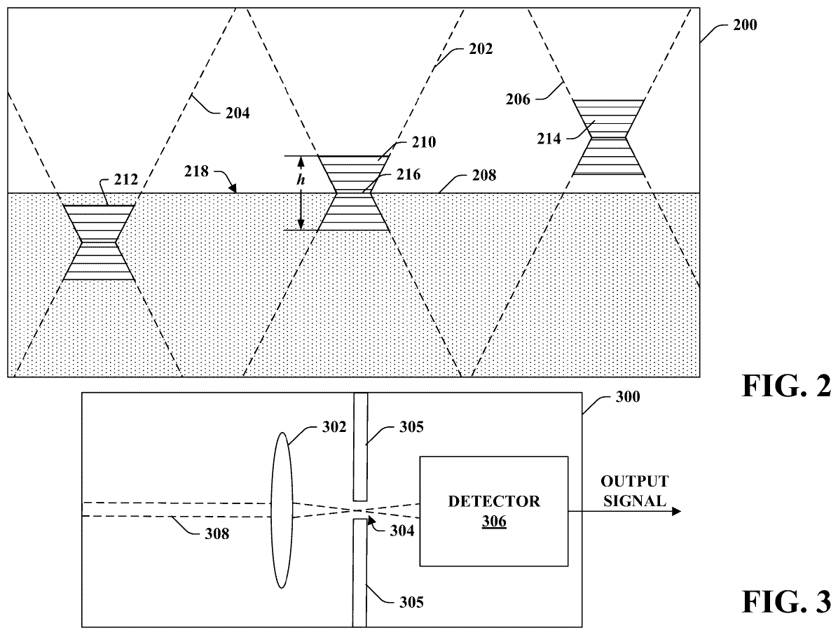

Referring now to FIG. 2, a side-view diagram 200 of incidence of three beams 202-206 on an exemplary workpiece 208 is shown. Within each of the beams 202-206 is defined a respective ablation region 210-214, within which power imparted by the beam to material of the workpiece 208 is sufficient to ablate the workpiece 208. Outside of the ablation regions 210-214, the beams 202-206 have insufficient power per unit area to cause ablation of the material of the workpiece 208. As a result, ablation or lack of ablation of the workpiece 208 depends on fine control of locations of focal spots of the beams 202-206. The first beam 202 has a focal spot 216 that is positioned on a surface 218 of the workpiece 208. Thus, the ablation region 210 defined by the first beam 202 extends from the surface 218 into the workpiece 208 to a depth defined by a size of the ablation region 210. In exemplary embodiments, a height h of an ablation region can be less than or equal to 10 microns, less than or equal to 5 microns, or less than or equal to 1 micron.

As indicated by FIG. 2, when the focal spot of a beam is positioned above or below the surface 218 of the workpiece 208, ablation may not occur. For example, the beam 206 has its ablation region 214 positioned entirely above the surface 218 of the workpiece 208, and thus the beam 206 has insufficient power per unit area within the workpiece 208 to cause ablation. The beam 204 has its ablation region 212 positioned entirely below the surface 218 of the workpiece 208. Whether the beam 204 causes ablation of the workpiece 208 depends on absorption of the beam 204 by the workpiece 208. If energy of the beam 204 is strongly absorbed by the workpiece 208 before it reaches the ablation region 212, the beam 204 may not have sufficient energy within its usually-defined ablation region 212 to actually cause ablation of the workpiece 208. Hence, it is to be appreciated that ablation may or may not occur within the region of a beam defined as its “ablation region” depending on other operational factors pertaining to laser ablation systems described herein.

From the foregoing, it is to be appreciated that in the system 100, fine control of a location of the focal spot 118 may be desirable. A laser ablation system can further include a conventional microscope and/or a confocal microscope for feedback control. For example, the system 100 can further include a microscope 122. The microscope 122 can be a conventional microscope or a confocal microscope. The focusing system 106 can be configured to receive a reflection of the beam 116 from the workpiece 108, and to direct a reflected beam 123 to the microscope 122. The microscope 122 can include a detector 124 that is configured to output, to the computing device 102, an indication of light incident on the detector 124.

In an exemplary embodiment, the microscope 122 is a conventional microscope and the detector 124 can be or include an imaging sensor such as a charge-coupled device (CCD) that is configured to output two-dimensional images of a surface of the workpiece 108 in proximity to the focal spot 118. In such embodiments, the process control component 114 can determine a position of the focal spot 118 on the workpiece 108 based upon the images output by the detector 124 (e.g., by employing one or more image recognition algorithms or techniques). The process control component 114 can then control a position of the focal spot 118 on or within the workpiece 108 based upon the determined position of the focal spot 118.

The process control component 114 can determine the position of the focal spot 118 in x-, y-, and z-directions. In other words, the process control component 114 can determine an x-y position of the focal spot 118 along a surface of the workpiece 108.

The process control component 114 can further determine whether 1) the focal spot 118 is positioned on a surface 126 of the workpiece 108 or whether 2) the focal spot 118 is positioned at a height above the surface 126 of the workpiece 108 or at a depth below the surface 126 of the workpiece 108. In an exemplary embodiment, the process control component 114 receives an image of the surface 126 in a region that includes the focal spot 118. The image includes a depiction of an incidence spot of the beam 116 on the surface 126 of the workpiece 108. The incidence spot of the beam 116 is an area of the surface 126 that is struck by the beam 116. When the focal spot 118 of the beam 116 is not positioned on the surface 126 of the workpiece 108, the incidence spot of the beam 116 is larger than the focal spot 118. The process control component 114 can be programmed with an expected incidence spot size at the surface 126 of the workpiece 108. The process control component 114 can determine whether the focal spot 118 is positioned at the surface 126 based upon the image of the surface 126 and the expected incidence spot size.

In an example, the process control component 114 can employ image processing to determine pixels of the image of the surface 126 that are representative of the incidence spot of the beam 116. Based upon such determination, the process control component 114 computes a size of the incidence spot. The process control component 114 compares the computed size of the incidence spot to the expected incidence spot size. If the computed size of the incidence spot is greater than the expected incidence spot size, the process control component 114 determines that the focal spot 118 is not located at the surface 126. Responsive to determining that the focal spot 118 is not located at the surface 126, the process control component 114 can control the stage 120, the focusing system 106, and/or the laser 104 to effectuate movement of the focal spot 118 to the surface 126 of the workpiece 108.

It is to be appreciated that a spot within which ablation actually occurs (i.e., an ablation spot) may be smaller than an incidence spot on the surface 126 of the workpiece 108 due to a non-uniform distribution of power imparted by the beam 116 across the incidence spot. In exemplary embodiments, an ablation spot size can be, e.g., less than 2 microns, less than or equal to one micron, or less than or equal to 500 nanometers

In another exemplary embodiment, the microscope 122 can be a confocal microscope and the detector 124 can be configured to output, to the computing device 102, an indication of an intensity of the reflected light 123 incident on the detector 124. In embodiments wherein the microscope 122 is a confocal microscope, the light 123 incident on the detector 124 tends toward a maximum intensity when the focal spot 118 is positioned on a surface of the workpiece 108.

Referring now to FIG. 3, an exemplary confocal microscope system 300 is shown. The confocal microscope system 300 includes an objective lens 302, a pinhole 304 (e.g., formed in a plate 305), and a detector 306. The objective lens 302 receives light 308 reflected from the surface of an ablation workpiece (e.g., the reflected light 123), and focuses this light 308 through the pinhole 304. The detector 306 is configured to output a signal indicative of an intensity of the light 308 that the detector 306 receives.

When the focal spot 118 is positioned on a surface 126 of the workpiece 108, the reflected light 123 will be collimated after it reflects back through an objective lens of the focusing system 106. When the focal spot 118 is not positioned on the surface 126 of the workpiece 108, the reflected light 123 will not be collimated after it reflects back through the objective lens of the focusing system 106. The objective lens 302 of the confocal microscope system 300 and the pinhole 304 are configured such that when the reflected light 308 is collimated (indicating that the focal spot 118 is positioned on the surface 126 of the workpiece 108), the light 308 is focused through the pinhole 304, whereupon the light 308 is incident on the detector 306. When the reflected light 308 is uncollimated, the light 308 is not well-focused through the pinhole 304 and the light 308 is substantially blocked from reaching the detector 306 by the pinhole 304. Thus, when the focal spot 118 is positioned on the surface 126 of the workpiece 108, the signal output by the detector 306 is at its maximum. Referring once again to FIG. 1, in embodiments wherein the microscope 122 is a confocal microscope, the process control component 114 can determine that the focal spot 118 is at the surface 126 of the workpiece 108 based upon the signal output by the detector 124. For instance, the process control component 114 can determine that the focal spot 118 is at the surface 126 of the workpiece 108 based upon the signal output by the detector 124 being at its maximum. In another example, the process control component 114 determines that the focal spot 118 is within a threshold distance of the surface 126 of the workpiece 108 based upon the signal output by the detector 124 being above a threshold that indicates that the reflected light 123 is well-focused through a pinhole filter included in the microscope 122.

In various exemplary embodiments the system 100 can include the microscope 122 and one or more additional microscopes (not shown). For example, the microscope 122 can be or include a confocal microscope, and the system 100 can further include a conventional microscope. In such embodiments, each of the confocal microscope and the conventional microscope can output data, to the computing device 102, that are indicative of a position of the focal spot 118 on or in the workpiece 108.

In some embodiments, the process control component 114 can reduce the power output of the laser 104 in order to cease ablation by the beam 118, while maintaining the laser 104 in an “on” operating condition. In these embodiments, the microscope 122 continues to receive the reflected light 123, and the process control component 114 can determine a position of the focal spot 118 on or in the workpiece 108 based upon data output by the detector 124.

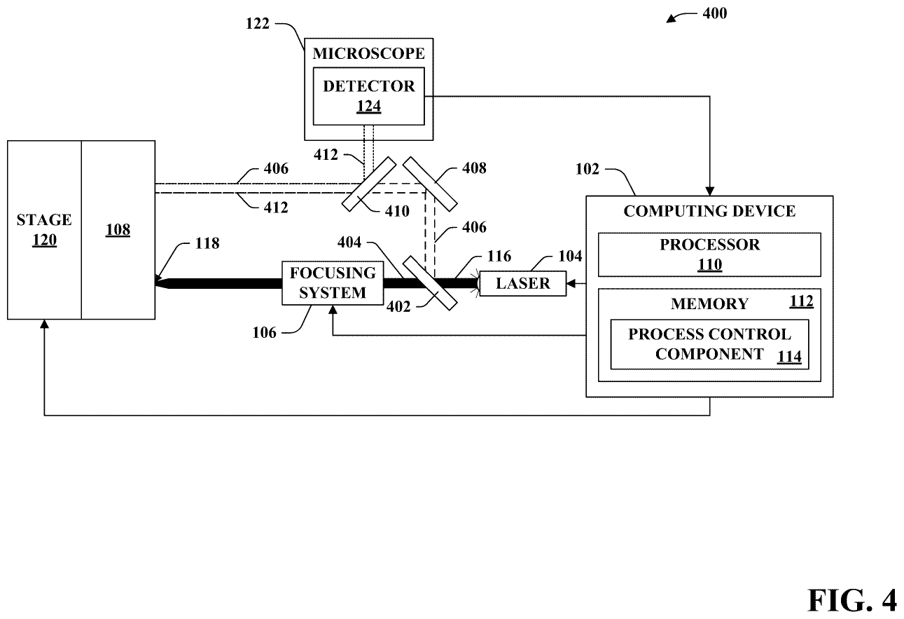

A laser ablation system that includes one or more microscopes can further include a beam splitter or a spatial light modulator that is configured to provide a secondary beam that can be reflected from the workpiece and to the one or more microscopes in order to determine a location of a surface of the workpiece. For example, and referring now to FIG. 4, another exemplary laser ablation system 400 is illustrated. The system 400 includes the computing device 102, the laser 104, the focusing system 106, the workpiece 108, the stage 120, and the microscope 122. The system 400 further includes a beam splitter 402 that is disposed between the laser 104 and the focusing system 106. The laser 104 emits the beam 116 toward the beam splitter 402. In the system 400, the beam 116 serves as a primary beam. The beam splitter 402 splits the primary beam 116 into a secondary beam 404 (e.g., that is transmitted by the beam splitter) and a tertiary beam 406 (e.g., that is reflected by the beam splitter 402). The secondary beam 404 is received by the focusing system 106, which focuses the secondary beam 404 to the focal spot 118 on or in the workpiece 108.

The system 400 further comprises a mirror 408 and a second beam splitter 410. The mirror 408 receives the tertiary beam 406 from the first beam splitter 402 and directs the tertiary beam 406 to the second beam splitter 410. The second beam splitter 410 is configured to transmit the tertiary beam 406 toward the workpiece 108. The workpiece 108 reflects at least a portion of the light of the tertiary beam 406 as reflected tertiary beam 412. The reflected tertiary beam 412 is received by the second beam splitter 410 and directed toward the microscope 122.

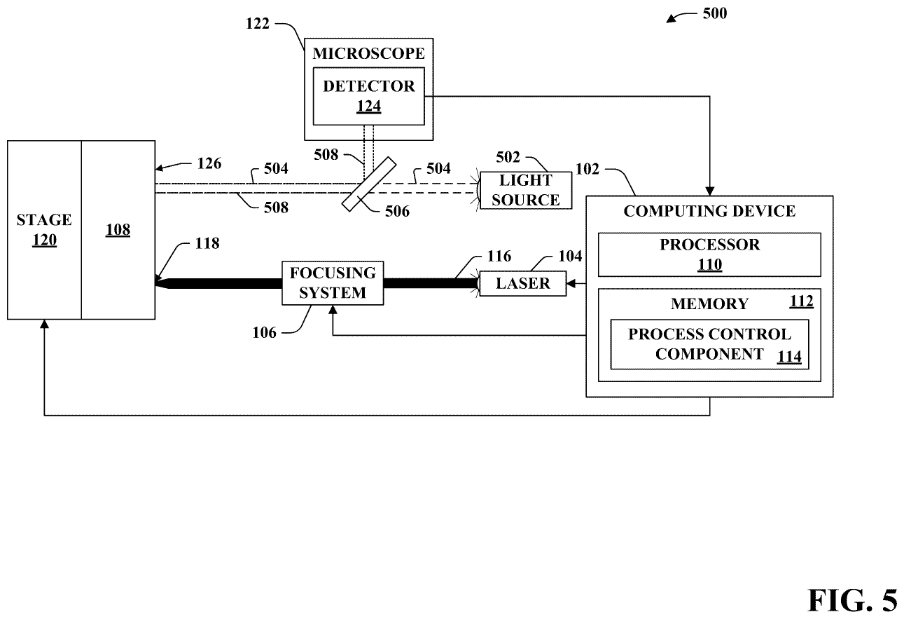

It is to be appreciated that in other embodiments a secondary light source can be used to determine a location of the surface 126 of the workpiece 108. Referring now to FIG. 5, yet another exemplary laser ablation system 500 is shown. The system 500 includes the computing device 102, the laser 104, the focusing system 106, the workpiece 108, the stage 120, and the microscope 122. The system 500 further includes a secondary light source 502 that emits secondary light 504. The secondary light source 502 can be a laser, or the secondary light source 502 can be another light source such as a lamp, an LED, or the like. The secondary light 504 is incident on the surface 126 of the workpiece 108. The system 500 further includes a beam splitter/mirror 206. The secondary light 504 is reflected from the surface 126 of the workpiece as reflected light 508. The reflected light 508 is directed by the beam splitter/mirror 506 to the microscope 122.

In some embodiments, the systems 100, 400, 500 can be configured to cause laser ablation within the workpiece 108 rather than at a surface of the workpiece 108. In these embodiments, the systems 100, 400 can create damage planes within the workpiece 108 along which the workpiece 108 can then be fractured to create desired forms.

Referring once again to FIG. 1, the workpiece 108 can be substantially transparent to wavelengths of light present in the beam 116 emitted by the laser 104. The focusing system 106 can be configured to focus the beam 116 such that the focal spot 118 is within the bulk of the workpiece 108 rather than at a surface of the workpiece 108. Until the beam 116 reaches the focal spot 118, individual photons can have insufficient energy to cause ablation. At the focal spot 118, the intensity of the beam 116 is sufficiently high that multiphoton absorption (MPA) occurs, and material is ablated at the focal spot 118.

In embodiments wherein the focal spot 118 is positioned within the bulk of the workpiece 108, it may be difficult to determine a location of the focal spot 118 so that the workpiece 108 is ablated in a desired manner. In these embodiments, the process control component 114 can reduce the power output of the laser 104 below an ablation threshold for the workpiece 108. The process control component 114 can identify a position at which the focal spot 118 is positioned on a surface of the workpiece 108 (e.g., based upon output of the detector 124 of the microscope 122). The process control component 114 can then control one or more of the focusing system 104 or the stage 120 to move the focal spot a known distance in one or more directions to reach a desired ablation location within the workpiece 108.

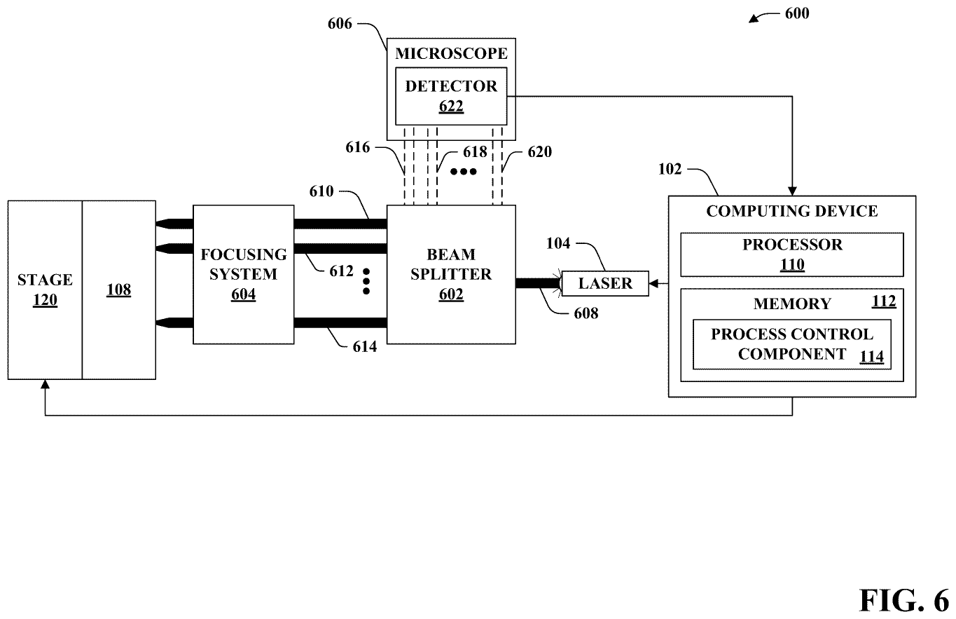

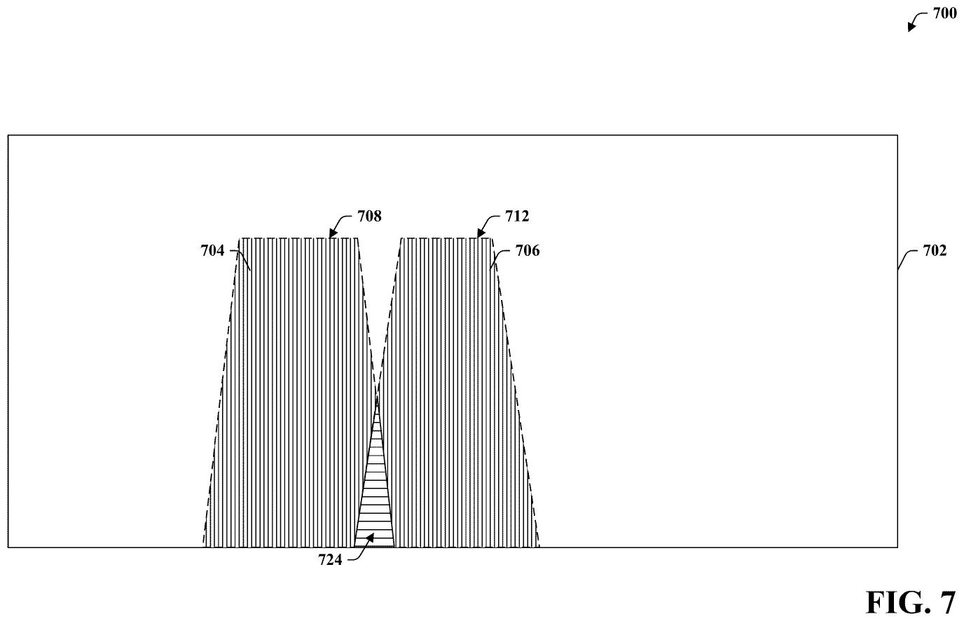

In some embodiments a laser ablation system can include optical elements that are configured to split a primary beam into a plurality of secondary beams, each of which performs ablation of the workpiece 108. By way of example, and referring now to FIG. 6, another exemplary laser ablation system 600 is shown. The system 600 comprises the computing device 102, the laser 104, the workpiece 108, and the stage 120. The system 600 further comprises a beam splitter 602, a focusing system 604, and a microscope 606. The process control component 114 of the computing device 102 controls operation of the laser 104 as described above. The laser 104 emits a primary beam 608 toward the beam splitter 602. The beam splitter 602 splits the primary beam 608 into a plurality of N secondary beams 610-614, where N is a positive integer. The beam splitter can be or include any of various optical components that can be collectively configured to split the primary beam 608 into the plurality of secondary beams 610-614. By way of example, and not limitation, the beam splitter 602 can be or include a diffraction grating, a digital micromirror device (DMD), a holographic beam splitter, or the like.

The secondary beams 610-614 are received by the focusing system 604 and are each focused to a respective focal spot on the workpiece 608. The focusing system 604 can be or include any of various optical elements that can receive the plurality of secondary beams 610-614 and focus those beams to respective focal spots on the workpiece 608. Pursuant to an example, the focusing system 604 can comprise a micro-lens array that includes a respective lens for each of the secondary beams 610-614. In such embodiments, the beam splitter 602 can be configured to direct the beams 610-614 each to their respective lens in the micro-lens array.

The laser 104 can be configured so that the primary beam 608 is sufficiently powerful for each of the secondary beams 610-614 to retain sufficient power to ablate the workpiece 108 at its focal spot. Thus, each of the secondary beams 610-614 causes ablation at a different location on or in the workpiece.

The focusing system 604 can be configured to direct beams that are reflected from the surface of the workpiece 108 back toward the beam splitter 602. The beam splitter 602 can include one or more components that are configured to direct such reflections toward the microscope 606. Thus, the microscope 606 can receive a plurality of reflected beams 616-620. In various embodiments, the reflected beams 616-620 can be reflections of the secondary beams 610-614 from the surface of the workpiece 608. In other embodiments, the reflected beams 616-620 can be reflections of beams that are distinct from the secondary beams 610-614 that are used to perform ablation of the workpiece 108. For instance, the focusing system 604 and/or the beam splitter 602 can include components similar to the beam splitters and mirrors 402, 408, 410 shown in FIG. 4. In another example, the system 600 can be modified to include a secondary light source and secondary optics, similar to those described above with respect to FIG. 5. A detector 622 included on the microscope 606 can be configured to output data indicative of each of the reflected beams 616-620 to the computing device 102. Such data can be employed by the process control component 114 for alignment and control purposes as described above. In exemplary embodiments, the detector 622 can include a plurality of detectors each of which receives light from a respective beam in the reflected beams 616-620. In such embodiments, the microscope 606 can be configured with distinct focusing optics for each of the reflected beams 616-620. For instance, when the microscope 606 is a confocal microscope, the microscope 606 can include a respective pinhole aperture through which each of the beams 616-620 passes prior to impinging on the detector 622.

In some embodiments, the focusing system 604 can include distinct optical focusing channels for each of the secondary beams 610-614. In various embodiments, however, the focusing system 604 can include one or more optical components that are shared by the secondary beams 610-614. Stated differently, the secondary beams 610-614 may all be incident on a common optical component included in the focusing system 604. Since each of the secondary beams 610-614 must be of sufficient intensity to cause ablation, the total power of the secondary beams 610-614 in combination may be sufficient to cause damage to the common optical component. Furthermore, within the bulk of the workpiece 108, the beams 610-614 may be sufficiently close together to overlap in locations away from their respective focal spots.

For example, and referring now to FIG. 7, a cross-sectional view 700 of a workpiece 702 is shown wherein a first laser beam 704 and a second laser beam 706 overlap within the workpiece 702. The first laser beam 704 has a focal spot 708 at which the intensity of the beam 704 is sufficient to cause ablation. The second laser beam 706 has a focal spot 712 at which intensity of the beam 706 is sufficient to cause ablation. Thus, the beams 704, 706 cause ablation at the focal spots 708, 712.

The laser beams 704, 706 overlap within a region 724 within the bulk of the workpiece 702. Whereas each of the beams 704, 706 individually may not have sufficient intensity to cause ablation except at their respective focal spots 708, 712, within the region 724 the overlap of the beams 704, 706 can provide sufficient intensity for ablation to occur. Thus, whereas it may be desirable that ablation occurs only in the vicinity of the focal spots 708, 712, ablation of the workpiece 702 can also occur in the overlap region 724 of the beams 704, 706. Thus, when the beams 704, 706 are sufficiently close together, ablation can occur at an unintended location in the workpiece 702.

Various approaches can be employed to mitigate these effects. Referring once again to FIG. 6, to avoid unintended ablation within the bulk of the workpiece 108, the focusing system 604 can include a DMD that can selectively deflect one or more of the secondary beams 610-614 away from the workpiece 108. The process control component 114 can be configured to control the DMD such that the beams 610-614 do not overlap within the workpiece 108. In various embodiments, the process control component 114 can selectively deflect the secondary beams 610-614 to precisely control a geometry of an ablated feature either within the workpiece 108 or on a surface of the workpiece 108. Furthermore, each of the beams 610-614 can impinge on multiple elements of the DMD. Thus, the process control component 114 can reduce the intensity of one or more of the beams 610-614 at the workpiece 108 by selectively deflecting some portion of the beam by way of a subset of the multiple elements of the DMD on which the beam impinges.

In a further example, the beam splitter 602 and/or the focusing system 604 can be configured such that the beams 610-614 are aimed at locations that are separated by distances that are at least as great as the maximal width of the beams 610-614 within the workpiece 108. In a non-limiting illustrative example, the beam 610 can be a widest of the beams 610-614 having a maximal width of x₁ within the workpiece 108. The process control component 142 can be configured such that none of the other beams 612-614 simultaneously illuminates any location that is within a distance x₁ of the beam 610. Respective widths of the beams 610-614 within the workpiece 108 can depend upon a depth of the respective focal spots of the beams 610-614 within the workpiece 108.

In further exemplary embodiments, the focusing system 604 can include an afocal system that is configured to cause each of the secondary beams 610-614 to traverse a different path length to reach its respective focal spot. By way of example, and not limitation, the afocal system can include a first beam expander that expands and spatially separates the beams 610-614. The afocal system can further include a second beam expander that returns the beams 610-614 to their original spatial arrangement. Due to the expansion of the beams 610-614 by the beam expanders, the beams 610-614 traverse different path lengths to their respective focal spots. In embodiments wherein the laser 104 is a pulsed laser (e.g., a femtosecond laser), the different path lengths traversed by the secondary beams 610-614 cause the peak intensity of each of the secondary beams 610-614 to be temporally offset from one another at the common optical component. Stated differently, the peak intensity of the first beam 610 can reach the common optical element at a first time, the peak intensity of the second beam 612 can reach the common optical element at a second time, and so on until the peak intensity of the Nth beam 614 reaches the common optical element at an Nth time. Thus, the common optical element does not experience the peak intensity of the primary beam 608. Furthermore, and referring once again to FIG. 7, the total intensity of the beams 704, 706 in the region 724 may be insufficient to cause ablation due to the temporal offset of the beams 704, 706, whereas the beams 704, 706 remain sufficiently intense that, at their focal spots 708, 712, the beams 704, 706 cause ablation.

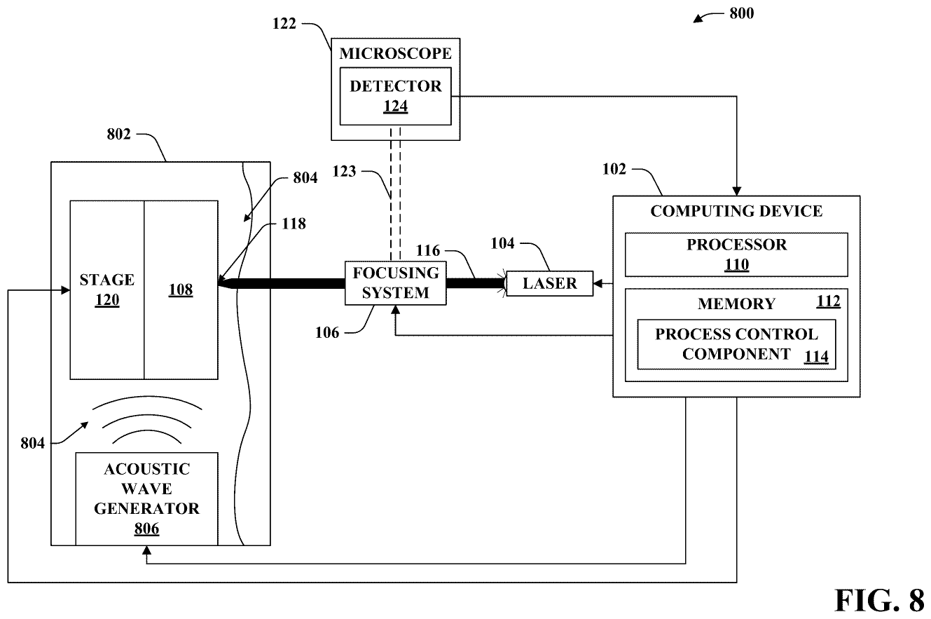

In some embodiments, an ablation surface can be placed in a liquid to reduce redeposition of ablated material. By way of example, and referring now to FIG. 8, another exemplary ablation system 800 is shown. The ablation system 800 includes the computing device 102, the laser 104, the focusing system 106, the workpiece 108, the stage 120, and the microscope 122. The system 800 further includes a tank 802 that contains a liquid 804. The workpiece 108 and the stage 120 can be positioned in the tank 802 such that the workpiece 108 is immersed in the liquid 804. The liquid 804 can be substantially transparent to the beam 116 such that the beam 116 propagates through the liquid 804 to a surface of the workpiece 108. The liquid 804 can prevent material ablated from the workpiece 108 from being blasted back toward the optical elements of the focusing system 106. Furthermore, the system 800 can include an acoustic wave generator 806 that is configured to propagate acoustic waves 808 through the liquid 804. The acoustic waves 808 can help prevent ablated material from redepositing on the surface of the workpiece 108, and can further help flush ablated material from high-aspect-ratio features being ablated in the workpiece 108 by the beam 116. The acoustic wave generator 806 can be configured to generate ultrasonic waves (e.g., waves having frequency between about 20 and about 200 kHz) or megasonic waves (e.g., waves having frequency between about 500 kHz and about 2 MHz).

In various embodiments described herein, the process control component 114 can control any of the systems 100, 400, 500, 600, 800 to create complex three-dimensional features on a non-planar surface of the workpiece 108. In a non-limiting example, and referring once again to FIG. 6, the process control component 114 can receive data from the detector 622 that is indicative of a three-dimensional surface of the workpiece 108 either during ablation by the secondary beams 610-614 or during a pause in ablation when the intensity of the beams 610-614 is kept low enough that ablation does not occur. For instance, the detector 622 can output data indicative of depths of points on the surface of the workpiece 608 from which each of the reflected beams 616-620 were received. In further embodiments, the detector 622 can output an image of an ablation surface of the workpiece 108. Based upon the depths of the points and the image of the ablation surface, the process control component 114 can identify an approximate surface contour of the ablation surface of the workpiece 108 and positions of focal spots of the ablation beams 610-614 on the ablation surface. The process control component 114 can then control operation of the beams 610-614 (e.g., by selectively turning the beams on or off using a DMD included in the beam splitter 602 or the focusing system 604) to cause the beams 610-614 to ablate complex, three-dimensional micro-scale features in a non-planar surface of the workpiece 108.

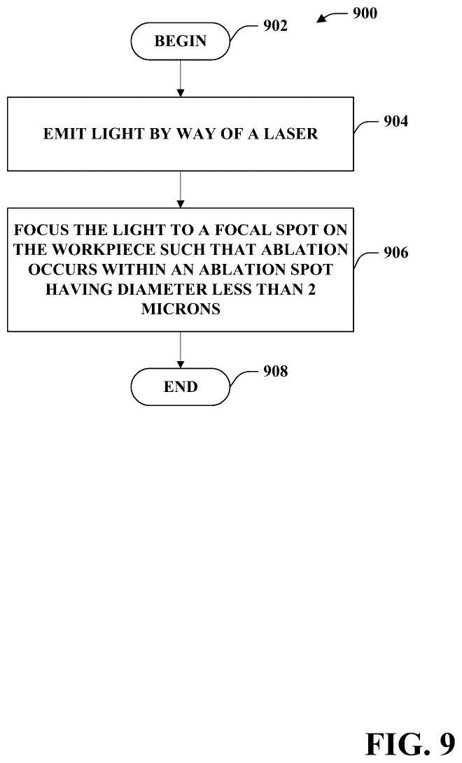

Referring now to FIG. 9, an exemplary methodology 900 pertaining to selective laser ablation is illustrated. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodology can be stored in a computer-readable medium, displayed on a display device, and/or the like.

The methodology 900 begins at 902 and at 904 light is emitted by way of a laser. The laser can be, for example, a pulsed femtosecond laser. At 906, the light emitted by the laser is focused, by way of a focusing system, to a focal spot on a workpiece that is desirably ablated. The focusing system focuses the light to the focal spot such that ablation occurs at the focal spot. The focusing system can focus the light to the focal spot such that a size of an ablation spot (e.g., centered at the focal spot) is less than 2 microns in diameter. At 908 the methodology 900 ends.

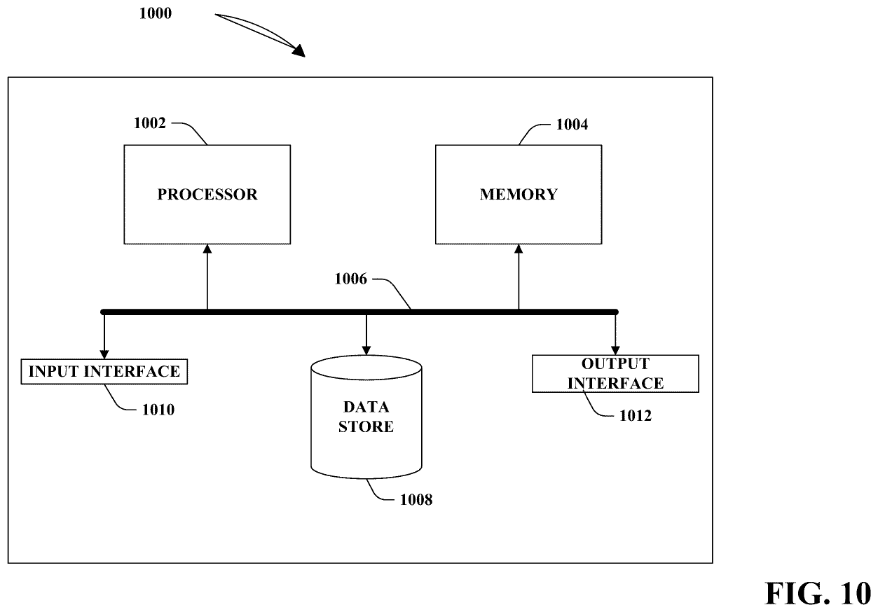

Referring now to FIG. 10, a high-level illustration of an exemplary computing device 1000 that can be used in accordance with the systems and methodologies disclosed herein is illustrated. For instance, the computing device 1000 may be used to control operation of a system for laser ablation (e.g., the system 100, the system 400, the system 500, the system 600, or the system 800). The computing device 1000 includes at least one processor 1002 that executes instructions that are stored in a memory 1004. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store images of a workpiece, a computer-implemented definition of a pattern to be ablated from a workpiece, various ablation processing parameters, etc.

The computing device 1000 additionally includes a data store 1008 that is accessible by the processor 1002 by way of the system bus 1006. The data store 1008 may include executable instructions, computer-implemented ablation pattern definitions, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

It is contemplated that the external devices that communicate with the computing device 1000 via the input interface 1010 and the output interface 1012 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1000 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1000 may be a distributed system. Thus, for instance, several devices may be in communication by way of a network connection and may collectively perform tasks described as being performed by the computing device 1000.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Systems and methods are disclosed herein in accordance with at least the following examples.

(A1) In an aspect, a method for laser ablation includes emitting light by way of a laser. The method also includes focusing the light emitted by the laser to a focal spot on a surface of a workpiece by way of a focusing system, such that the focused light causes ablation of the workpiece within an ablation spot having a diameter of less than 2 microns at the surface of the workpiece.

(A2) In some embodiments of the method of (A1), the focused light comprises a beam that defines an ablation region, wherein within the ablation region the beam has sufficient intensity to cause ablation of a material of the workpiece and outside the ablation region the beam does not have sufficient intensity to cause ablation of the material.

(A3) In some embodiments of the method of (A2), the ablation region has a height along the beam of less than or equal to 10 microns.

(A4) In some embodiments of the method of at least one of (A1)-(A3), the focusing system has a numerical aperture of greater than or equal to 0.15.

(A5) In some embodiments of the method of at least one of (A1)-(A4), the method also includes determining a position of the focal spot relative to the surface of the workpiece. The method additionally includes moving the position of the focal spot based upon the determined position of the focal spot relative to the surface such that ablation continues to occur on the surface.

(A6) In some embodiments of the method of (A5), determining the position of the focal spot relative to the surface is performed while the focused light is ablating the workpiece.

(B1) In another aspect, a laser ablation system includes a laser, a focusing system, and a computing device. The computing device is configured to perform acts that include controlling operation of the laser and the focusing system such that the laser emits light that is focused by the focusing system to a focal spot on a surface of a workpiece, where the focused light causes ablation of the workpiece within an ablation spot having a diameter of less than 2 microns on the surface of the workpiece.

(B2) In some embodiments of the laser ablation system of (B1), the focusing system has a numerical aperture greater than or equal to 0.15 with respect to the focused light.

(B3) In some embodiments of the laser ablation system of at least one of (B1)-(B2), the diameter of the ablation spot is a first diameter, wherein the focal spot has a second diameter, the second diameter greater than the first diameter.

(B4) In some embodiments of the laser ablation system of at least one of (B1)-(B3), the laser ablation system further comprises a beam splitter, where the beam splitter receives the light emitted by the laser and splits the light into a plurality of beams, where the focusing system receives the plurality of beams and focuses the beams to a plurality of respective focal spots on the surface of the workpiece such that ablation occurs at the plurality of respective focal spots, the focal spot included among the plurality of respective focal spots.

(B5) In some embodiments of the laser ablation system of (B4), the laser is a pulsed laser. Further, the acts also include controlling at least one of the laser, the beam splitter, or the focusing system such that beams in the plurality of beams are temporally offset from one another.

(B6) In some embodiments of the laser ablation system of at least one of (B4)-(B5), the plurality of beams are spaced such that the beams do not overlap within a body of the workpiece.

(B7) In some embodiments of the laser ablation system of at least one of (B1)-(B6), the focused light comprises a beam of light, where the beam of light defines an ablation region within which an intensity of the beam of light is sufficient to cause ablation of the workpiece, wherein the ablation region has a height of less than 10 microns.

(B8) In some embodiments of the laser ablation system of at least one of (B1)-(B7), the laser ablation system further comprises a confocal microscope system. The confocal microscope system includes an objective lens that receives light reflected from the surface of the workpiece at the focal spot. The confocal microscope system also includes a pinhole through which the objective lens focuses the light reflected from the surface of the workpiece. The confocal microscope system additionally includes a detector that is configured to receive light passing through the pinhole and to output a signal indicative of light that impinges on the detector.

(B9) In some embodiments of the laser ablation system of (B8), the acts additionally include determining that the focal spot of the focused light is within a threshold distance of the surface of the workpiece based upon the signal output by the detector.

(B10) In some embodiments of the laser ablation system of at least one of (B1)-(B9), the laser ablation system also includes an imaging sensor, where the focusing system is further configured to receive light reflected from the surface of the workpiece at the focal spot and to focus the reflected light onto the imaging sensor such that the imaging sensor outputs an image of the surface of the workpiece. The acts also include computing a size of the focal spot based upon the image of the surface of the workpiece. The acts additionally include determining, based upon the computed size of the focal spot, that the focal spot is incident on the surface of the workpiece.

(B11) In some embodiments of the laser ablation system of at least one of (B1)-(B10), the focusing system is configured such that ablation of the workpiece does not occur at a depth of greater than 5 microns below a position of the focal spot.

(C1) In yet another aspect, a system for laser ablation includes a laser, a beam splitter, a focusing system, and a computing device configured to perform acts. The acts include controlling operation of the laser, the beam splitter, and the focusing system such that the laser emits a first beam of light that is received by the beam splitter, whereupon the beam splitter splits the first beam of light into a plurality of secondary beams of light, the secondary beams of light focused by the focusing system to respective focal spots on a surface of a workpiece, wherein the focused light causes ablation of the workpiece at the focal spots and within respective ablation spots each having a diameter of less than 2 microns.

(C2) In some embodiments of the system of (C1), the beam splitter includes a digital micromirror device (DMD) and the focusing system includes a micro-lens array, where the computing device controls operation of the DMD such that each of the secondary beams is directed toward a respective lens in the micro-lens array.

(C3) In some embodiments of the system of at least one of (C1)-(C2), the focusing system has a numerical aperture of at least 0.15.

(D1) In another aspect, a laser ablation system is configured to perform at least one of the methods disclosed herein (e.g., any of the methods of (A1)-(A6)).

(E1) In yet another aspect, disclosed herein is use of any of the systems described herein (e.g., any of the systems of (B1)-(B11) or (C1)-(C3)).

(F1) In still yet another aspect, disclosed herein are methods of making any of the systems described herein (e.g., any of the systems of (B1)-(B11) or (C1)-(C3)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A laser ablation system, comprising:
a laser;
a focusing system; and
a computing device configured to perform acts comprising:
controlling operation of the laser and the focusing system such that the laser emits light that is focused by the focusing system to a focal spot on a surface of a workpiece, wherein the focused light causes ablation of the workpiece within an ablation spot having a diameter of less than 2 microns on the surface of the workpiece.

2. The laser ablation system of claim 1, wherein the focusing system has a numerical aperture greater than or equal to 0.15 with respect to the focused light.

3. The laser ablation system of claim 1, wherein the diameter of the ablation spot is a first diameter, wherein the focal spot has a second diameter, the second diameter greater than the first diameter.

4. The laser ablation system of claim 1, further comprising a beam splitter, wherein the beam splitter receives the light emitted by the laser and splits the light into a plurality of beams, wherein the focusing system receives the plurality of beams and focuses the beams to a plurality of respective focal spots on the surface of the workpiece such that ablation occurs at the plurality of respective focal spots, the focal spot included among the plurality of respective focal spots.

5. The laser ablation system of claim 4, wherein the laser is a pulsed laser, the acts further comprising:
controlling at least one of the laser, the beam splitter, or the focusing system such that beams in the plurality of beams are temporally offset from one another.

6. The laser ablation system of claim 4, wherein the plurality of beams are spaced such that the beams do not overlap within a body of the workpiece.

7. The laser ablation system of claim 1, wherein the focused light comprises a beam of light, wherein the beam of light defines an ablation region within which an intensity of the beam of light is sufficient to cause ablation of the workpiece, wherein the ablation region has a height of less than 10 microns.

8. The laser ablation system of claim 1, further comprising a confocal microscope system, the confocal microscope system comprising:
an objective lens that receives light reflected from the surface of the workpiece at the focal spot;
a pinhole through which the objective lens focuses the light reflected from the surface of the workpiece; and
a detector that is configured to receive light passing through the pinhole and to output a signal indicative of light that impinges on the detector.

9. The laser ablation system of claim 8, the acts further comprising determining that the focal spot of the focused light is within a threshold distance of the surface of the workpiece based upon the signal output by the detector.

10. The laser ablation system of claim 1, further comprising an imaging sensor, wherein the focusing system is further configured to receive light reflected from the surface of the workpiece at the focal spot and to focus the reflected light onto the imaging sensor such that the imaging sensor outputs an image of the surface of the workpiece, and wherein the acts further comprise:
computing a size of the focal spot based upon the image of the surface of the workpiece; and
determining, based upon the computed size of the focal spot, that the focal spot is incident on the surface of the workpiece.

11. The system of claim 1, wherein the focusing system is configured such that ablation of the workpiece does not occur at a depth of greater than 5 microns below a position of the focal spot.

12. A method for laser ablation, comprising:
emitting light by way of a laser;
focusing the light emitted by the laser to a focal spot on a surface of a workpiece by way of a focusing system, such that the focused light causes ablation of the workpiece within an ablation spot having a diameter of less than 2 microns at the surface of the workpiece.

13. The method of claim 12, wherein the focused light comprises a beam that defines an ablation region, wherein within the ablation region the beam has sufficient intensity to cause ablation of a material of the workpiece and outside the ablation region the beam does not have sufficient intensity to cause ablation of the material.

14. The method of claim 13, wherein the ablation region has a height along the beam of less than or equal to 10 microns.

15. The method of claim 12, wherein the focusing system has a numerical aperture of greater than or equal to 0.15.

16. The method of claim 12, further comprising:
determining a position of the focal spot relative to the surface of the workpiece; and
moving the position of the focal spot based upon the determined position of the focal spot relative to the surface such that ablation continues to occur on the surface.

17. The method of claim 16, wherein the determining the position of the focal spot relative to the surface is performed while the focused light is ablating the workpiece.

18. A system for laser ablation, comprising:
a laser;
a beam splitter;
a focusing system; and
a computing device configured to perform acts comprising:
controlling operation of the laser, the beam splitter, and the focusing system such that the laser emits a first beam of light that is received by the beam splitter, whereupon the beam splitter splits the first beam of light into a plurality of secondary beams of light, the secondary beams of light focused by the focusing system to respective focal spots on a surface of a workpiece, wherein the focused light causes ablation of the workpiece at the focal spots and within respective ablation spots each having a diameter of less than 2 microns.

19. The system of claim 18, wherein the beam splitter comprises a digital micromirror device (DMD) and the focusing system comprises a micro-lens array, wherein the computing device controls operation of the DMD such that each of the secondary beams is directed toward a respective lens in the micro-lens array.

20. The system of claim 18, wherein the focusing system has a numerical aperture of at least 0.15.
